(19) United States
(12) Patent Application Publication
(10) Pub. No.: US 2004/0216567 A1
(43) Pub. Date: Nov. 4, 2004

(54) Wrench device with a socket assembly

(76) Inventor: Chih-Ching Hsien, Taichung Hsien (TW)

Correspondence Address: Chih-Ching Hsien, 235 Chung - Ho, Box 8-24, Taipei, TW

(21) Appl. No.: 10/842,348

(22) Filed: May 11, 2004

Related U.S. Application Data
(63) Continuation-in-part of application No. 10/429,029, filed on Apr. 30, 2003, now abandoned.

(51) Int. Cl. B25B 13/00

(52) U.S. Cl. 81/124.6

(57) ABSTRACT

A wrench socket assembly comprises a socket having a main body; the main body including: an upper end portion being coated with silver thin film and having an inside formed with a mounting recess; the mounting recess of the main body of the socket having a wall formed with at least one positioning hole; the upper end portion of the main body having a peripheral wall formed with at least one through hole penetrating through the peripheral wall of the mounting recess; and a lower end portion having a color different from that of the upper end portion. A wrench with a pin can be used with the socket. The pin can be locked into the through hole or the positioning hole of the mounting recess so as to fix the socket to the wrench.

The invention is a continuous in part of U.S. Pat. No. 10/429,029, filed at Apr. 30, 2003, invented and assigned to the inventor of the present invention, and thus the contents of the U.S. Pat. No. 10/429,029 is incorporated into the present invention as a part of the specification.

### BACKGROUND OF THE INVENTION

1. Field of the Invention

The present invention is relates to a socket assembly, and more particularly to a socket assembly both available for manually operated wrenches and the pneumatic wrenches, thereby enhancing the versatility of the socket assembly.

2. Description of the Related Art

A conventional socket shown in FIGS. 10 and 11 comprises a main body 60 having one end formed with a square mounting recess 63. The mounting recess 63 of the main body 60 has a wall formed with a plurality of positioning holes 64 for locking the positioning ball (not shown) of the driving stud (now shown) of a manually operated wrench (not shown). Thus, the main body 60 is combined with the manually operated wrench to operate and rotate a workpiece (not shown), such as a bolt or the like.

However, when the conventional socket is combined with the pneumatic wrench, the locket strength of the positioning ball of the driving stud is not large enough, so that the conventional socket is easily detached from the pneumatic wrench; thereby causing inconvenience to the user in operation.

### SUMMARY OF THE INVENTION

The primary objective of the present invention is to provide a socket assembly that is both available for the manually operated wrench and the pneumatic wrench, thereby enhancing the versatility of the socket assembly.

Another objective of the present invention is to provide a socket assembly, wherein the upper end portion and the lower end portion of the main body have different colors, thereby facilitating the user identifying the socket assembly.

A further objective of the present invention is to provide a socket assembly, wherein the upper end portion of the main body is coated with a silver thin film in an electroplating manner to prevent from producing a metallic oxidation effect and to prevent dust and erosion.

A further objective of the present invention is to provide a socket assembly, wherein the lower end portion of the main body is dyed with a black color to prevent from producing a metallic oxidation effect and to prevent dust and erosion.

To achieve above object, the present invention provides a wrench socket assembly comprises a socket having a main body; the main body including: an upper end portion being coated with silver thin film and having an inside formed with a mounting recess; the mounting recess of the main body of the socket having a wall formed with at least one recessed positioning hole; the upper end portion of the main body having a peripheral wall formed with at least one through hole penetrating through the peripheral wall of the mounting recess; and a lower end portion having a color different from that of the upper end portion. A wrench with a pin can be used with the socket. The pin can be locked into the through hole or the positioning hole of the mounting recess.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a socket assembly in accordance with the preferred embodiment of the present invention;

FIG. 2 is a side cross-sectional view of the socket assembly as shown in FIG. 1;

FIG. 3 is a side cross-section view of the socket assembly in accordance with the preferred embodiment of the present invention;

FIG. 4 is a side cross-section view of the socket assembly in accordance with another embodiment of the present invention;

FIG. 5 is a side cross-section view of the socket assembly in accordance with another embodiment of the present invention;

FIG. 6 is a lateral plan view of the socket assembly in accordance with another embodiment of the present invention;

FIG. 7 is a perspective view of a socket assembly in accordance with another embodiment of the present invention;

FIG. 8 is a lateral plan view of the socket assembly as shown in FIG. 7;

FIG. 9 is a side cross-sectional operational view of the socket assembly in accordance with another embodiment of the present invention;

FIG. 10 is a perspective view of a conventional socket in accordance with the prior art; and

FIG. 11 is a side cross-sectional view of the conventional socket as shown in FIG. 10.

### DETAILED DESCRIPTION OF THE INVENTION

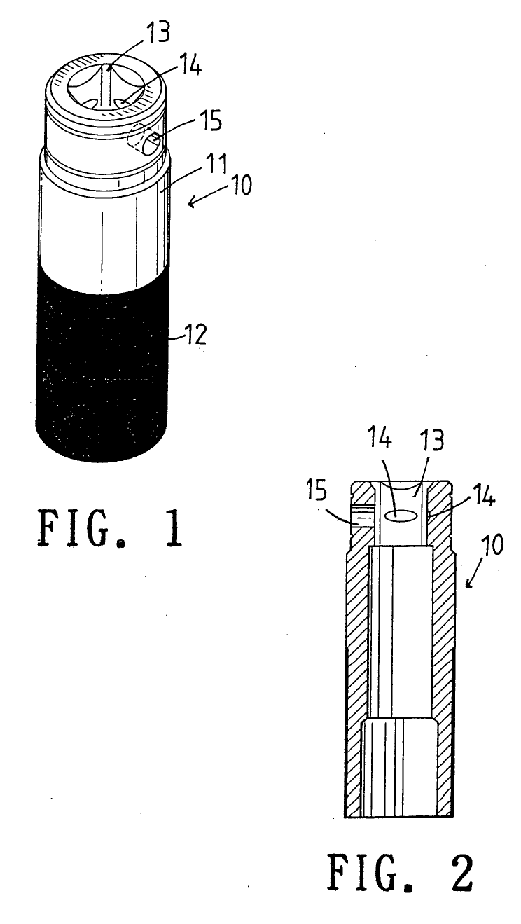

Referring to FIGS. 1 and 2, a socket assembly in accordance with the preferred embodiment of the present invention comprises a main body 10. The main body 10 includes an upper end portion 11 and a lower end portion 12. The upper end portion 11 of the main body 10 has an inside formed with a square mounting recess 13. At least one wall of the recess has a convex cambered surface. The wall of the mounting recess 13 has at least one positioning hole 14 for locking a positioning ball of a manually operated wrench. The upper end portion 11 of the main body 10 has a peripheral wall formed with a through hole 15 penetrating the peripheral wall of the mounting recess 13 for locking a positioning pin of a wrench.

Thus, the main body 10 of the socket assembly is combined with the manually operated wrench and the wrench to operate and rotate a workpiece, such as a bolt or the like.

In practice, the upper end portion 11 of the main body 10 is coated with a silver thin film by, for example, electroplate to prevent from producing a metallic oxidation effect and to prevent dust and erosion. In addition, the lower end portion 12 of the main body 10 is dyed with a black color to prevent from producing a metallic oxidation effect and to prevent dust and erosion. Thus, the upper end portion 11 of the main body 10 has a silver color and the lower end portion 12 of the main body 10 has a black color, thereby forming a contrast effect, so that the user can identify that the socket assembly is both available for the manually operated wrench and the wrench.

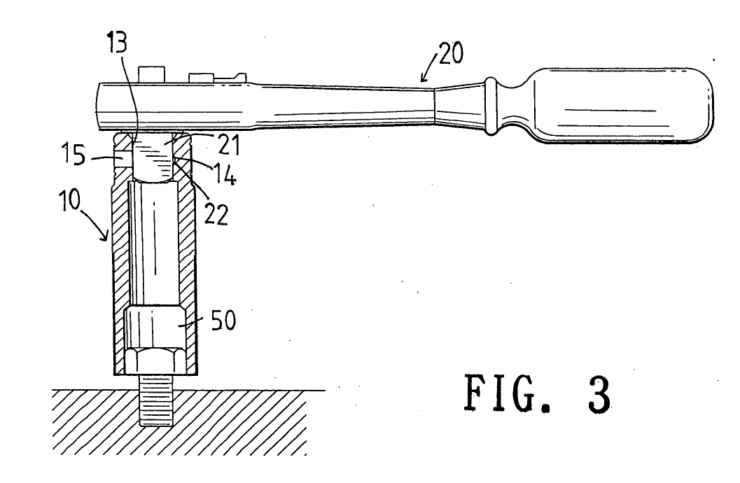

Referring to FIG. 3, a manually operated wrench 20 has a driving stud 21 inserted into the mounting recess 13 of the main body 10. The driving stud 21 of the manually operated wrench 20 is provided with a positioning ball 22 locket in one of the positioning holes 14 of the main body 10, so that the main body 10 of the socket assembly is combined with the manually operated wrench 20 to operate and rotate a workpiece 50, such as a bolt or the like.

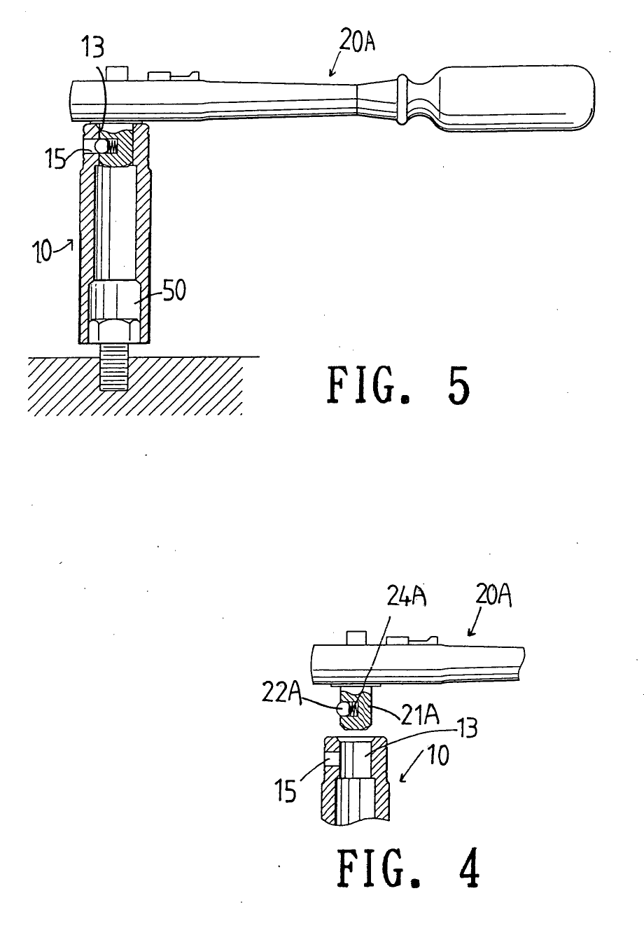

Referring to FIGS. 4 and 5, a manually operated wrench 20A has a driving stud 21A inserted into the mounting recess 13 of the main body 10. The driving stud 21A of the manually operated wrench 20A is provided with a positioning ball 22A locked in the through hole 15 of the main body 10, and an elastic member 24A urged on the positioning ball 22A, so that the main body 10 of the socket assembly is combined with the manually operated wrench 20A to operate and rotate the workpiece 50.

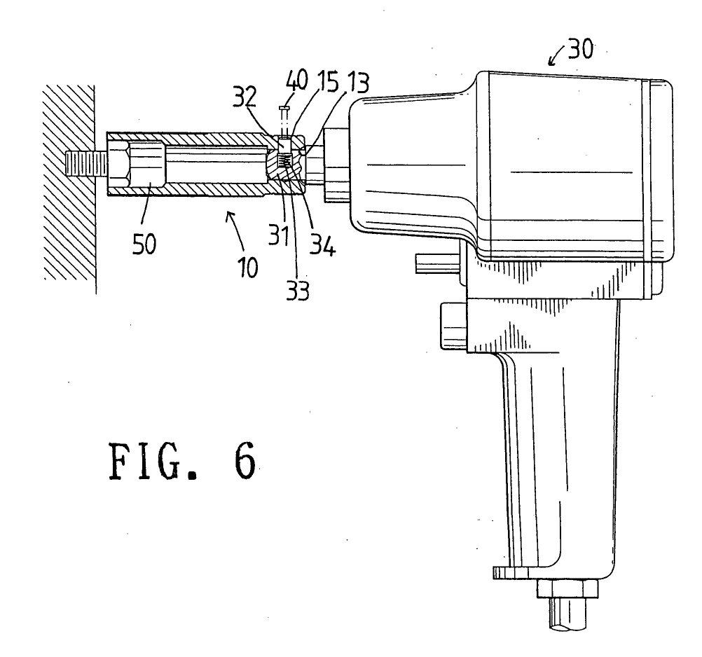

Referring to FIG. 6, a wrench 30 has a driving stud 31 inserted into the mounting recess 13 of the main body 10. The driving stud 31 of the wrench 30 is provided with a positioning pin 32 locked in the through hole 15 of the main body 10, and an elastic member 34 urged on the positioning pin 32, so that the main body 10 of the socket assembly is combined with the wrench 30 to operated and rotate the workpiece 50.

Preferably, the driving stud 31 of the wrench 30 is formed with a receiving chamber 33 to receive the positioning pin 32 and the elastic member 34 therein. In addition, an urging plate 40 is mounted in the receiving chamber 33 of the wrench 30 to compress the positioning pin 32 and the elastic member 34, so that the driving stud 31 of the wrench 30 is inserted into the mounting recess 13 of the main body 10 easily and conveniently. Then, the main body 10 of the socket assembly can be rotated relative to the wrench 30 until the positioning pin 32 of the wrench 30 aligns with the through hole 15 of the main body 10, so that the positioning pin 32 of the wrench 30 is inserted into and locked in the through hole 15 of the main body 10 by the restoring force of the elastic member 34 and the urging plate 40 is pressed outward by the positioning pin 32 to detach from the through hole 15 of the main body 10, so that the main body 10 of the socket assembly is combined with the wrench 30.

On the contrary, the urging plate 40 can be operated in a reverse manner, so that the main body 10 of the socket assembly is detached from the wrench 30.

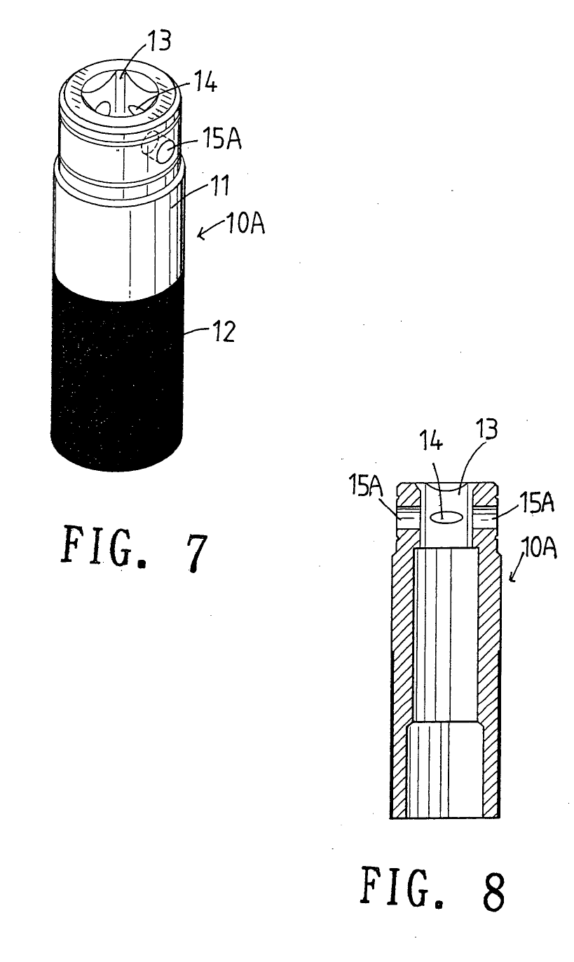

Referring to FIGS. 7 and 8, the socket assembly in accordance with another embodiment of the present invention is shown, wherein the upper end portion 11 of the main body 10A has a peripheral wall formed with two radially opposite through holes 15A each communicating with the mounting recess 13.

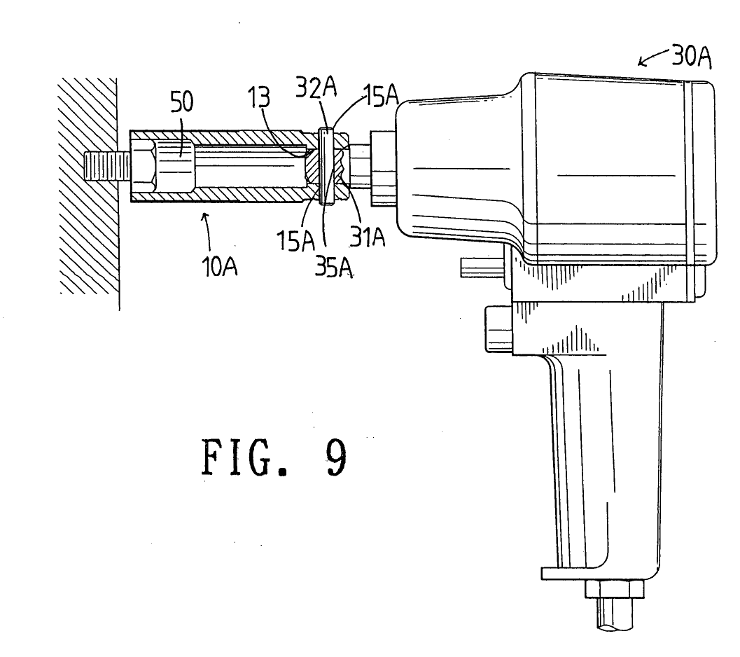

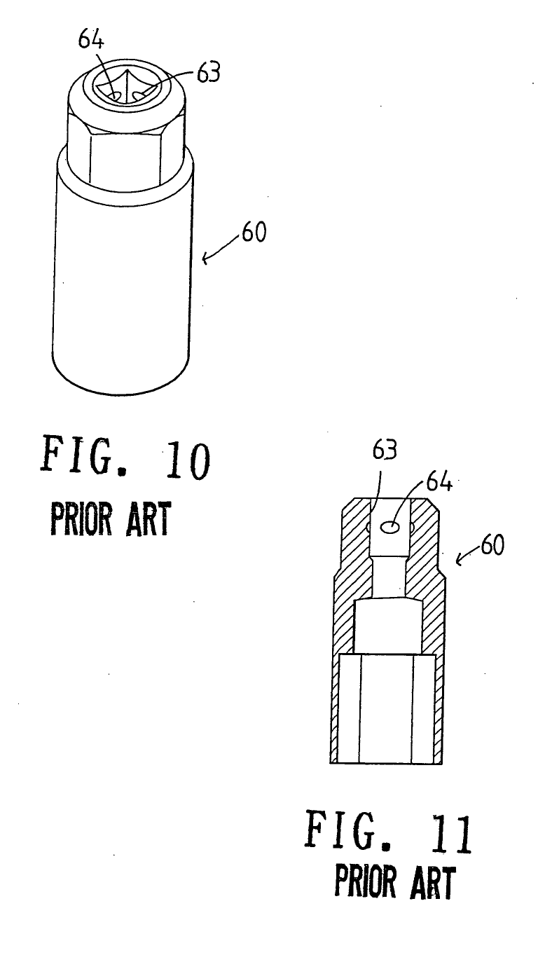

Referring to FIG. 9, the wrench 30A has a driving stud 31A inserted into the mounted recess 13 of the main body 10A. The driving stud 31A of the wrench 30A is formed with a shaft hole 35A penetrating the driving stud 31A for receiving a positioning pin 32A which locked in the through holes 15A of the main body 10A, so that the main body 10A of the socket assembly is combined with the wrench 30A to operate and rotate the workpiece 50.

In above mentioned structure, the wrench can be an electric driven wrench or a pneumatic wrench or a manual operated wrench.

Although the invention has been explained in relation to its preferred embodiments as mentioned above, it is to be understood that many other possible modifications and variations can be made without departing from the scope of the present invention. It is, therefore, contemplated that the appended claim or claims will cover such modifications and variations that fall within the true scope of the invention.

1. A wrench socket assembly, comprising
a socket having a main body; the main body including:
an upper end portion being coated with silver thin film and having an inside formed with a mounting recess; the mounting recess of the main body of the socket having a wall formed with at least one positioning hole; the upper end portion of the main body having a peripheral wall formed with at least one through hole penetrating through the peripheral wall of the mounting recess; and
a lower end portion having a color different from that of the upper end portion.

2. The wrench socket assembly as claimed in claim 1, wherein the lower end portion of the main body of the socket is dyed with a black color.

3. The wrench socket assembly as claimed in claim 1, wherein the mounting recess having two through holes at opposite sides.

4. A wrench device with a socket assembly, comprising
a socket having a main body; the main body including:
an upper end portion being coated with silver thin film and having an inside formed with a mounting recess; the mounting recess of the main body of the socket having a wall formed with at least one positioning hole; the upper end portion of the main body having a peripheral wall formed with at least one through hole penetrating through the peripheral wall of the mounting recess; and
a lower end portion having a color different from that of the upper end portion.
a wrench having a driving stud insertable into the mounting recess of the main body, the driving stud having
a positioning pin capable of being locked in the through hole of the main body of the socket;
an elastic member for driving the positioning pin so that the main body of the socket is combined with the wrench; and
a receiving chamber for receiving the positioning pin and the elastic member.

5. The wrench device with a socket assembly as claimed in claim 4, further comprising:
an urging plate for compressing the positioning pin and the elastic member to enter into the receiving chamber from one of the through holes for moving the driving stud of the wrench.

6. The wrench device with a socket assembly as claimed in claim 4, wherein the mounting recess has two through holes at two opposite sides.

7. The wrench socket assembly as claimed in claim 4, wherein the pin has shape like a ball.

8. The wrench device with a socket assembly as claimed in claim 4, wherein the wrench is one of manual operated wrench, electric driving wrenches and pneumatic wrenches.

9. A wrench device with a socket assembly, comprising
a socket having a main body; the main body including:
an upper end portion being coated with silver thin film and having an inside formed with a mounting recess; the mounting recess of the main body of the socket having a wall formed with at least one positioning hole; the upper end portion of the main body having a peripheral wall formed with two through holes at two opposite sides of the periphery wall and penetrating through the peripheral wall of the mounting recess; and
a lower end portion having a color different from that of the upper end portion.
a wrench having a driving stud insertable into the mounting recess of the main body, the driving stud having
a shaft hole penetrating the driving stud;
a positioning pin capable of being passing through the shaft hole and two through holes of the upper end portion of the main body for locking the socket to the driving stud of the wrench.
